(19) United States
(12) Patent Application Publication
(10) Pub. No.: US 2007/0174556 A1
(43) Pub. Date: Jul. 26, 2007

(54) Methods and apparatus for reducing command reissue latency

(75) Inventors: Jeffrey D. Brown, Rochester, MN (US); Michael J. Carnevale, Rochester, MN (US); Charles R. Johns, Austin, TX (US); David J. Krolak, Rochester, MN (US); Thuong Q. Truong, Austin, TX (US)

Correspondence Address: IBM Corporation;Intellectual Property Law Dept. 917, 3605 Hwy. 52 North, Rochester, MN, 55901, US

(73) Assignee: INTERNATIONAL BUSINESS MACHINES CORPORATION, ARMONK, NY (US)

(21) Appl. No.: 11/340,751

(22) Filed: Jan. 26, 2006

(51) Int. Cl. G06F 13/00

(52) U.S. Cl. 711/141

(57) ABSTRACT

In a first aspect, a first method of reducing reissue latency of a command received in a command processing pipeline from one of a plurality of units coupled to a bus is provided. The first method includes the steps of (1) from a first unit coupled to the bus, receiving a first command on the bus requiring access to a cacheline; (2) determining a state of the cacheline required by the first command by accessing cacheline state information stored in each of the plurality of units; (3) determining whether a second command received on the bus requires access to the cacheline before the state of the cacheline is returned to the first unit; and (4) if so, storing the second command in a buffer. Numerous other aspects are provided.

### FIELD OF THE INVENTION

The present invention relates generally to computer systems, and more particularly to methods and apparatus for reducing command reissue latency.

### BACKGROUND

A computer system may include one or more processors, I/O devices and/or memories which may be coupled to a bus. The bus may receive commands which require bus access from a processor or an I/O device. In this manner, a processor and/or an I/O device may be granted bus access, and consequently, may access a cacheline of memory, for example. A conventional computer system may receive a first command requiring bus access and access to a first memory cacheline so that the first command may update the first memory cacheline. Subsequently, the conventional computer system may receive a second command requiring bus access and access to the first memory cacheline so that, similar to the first command, the second command may update the first memory cacheline. If the second command is received shortly after the first command, the second command may require access to the first memory cacheline before the first command determines a state of the cacheline.

To maintain coherency (e.g., cache coherency), a conventional computer system may subsequently retry the second command. More specifically, the conventional computer system may have the originator (e.g., source) of the second command reissue the command at a later time. In this manner, the conventional computer system may enable the first command to update the first memory cacheline before allowing the second command to access the first memory cacheline. However, retrying the second command at a later time introduces undesired command reissue latency. Accordingly, improved methods and apparatus for command processing are desired.

### SUMMARY OF THE INVENTION

In a first aspect of the invention, a first method of reducing reissue latency of a command received in a command processing pipeline from one of a plurality of units coupled to a bus is provided. The first method includes the steps of (1) from a first unit coupled to the bus, receiving a first command on the bus requiring access to a cacheline; (2) determining a state of the cacheline required by the first command by accessing cacheline state information stored in each of the plurality of units; (3) determining whether a second command received on the bus requires access to the cacheline before the state of the cacheline is returned to the first unit; and (4) if the second command received on the bus requires access to the cacheline before the state of the cacheline is returned to the first unit, storing the second command in a buffer.

In a second aspect of the invention, a first apparatus for reducing reissue latency of a command received in a command processing pipeline from one of a plurality of units coupled to a bus is provided. The first apparatus includes latency-reducing logic including (1) a buffer; and (2) a command processing pipeline coupled to the buffer. The latency-reducing logic is adapted to (a) from a first unit coupled to the bus, receive a first command on the bus requiring access to a cacheline; (b) determine a state of the cacheline required by the first command by accessing cacheline state information stored in each of the plurality of units; (c) determine whether a second command received on the bus requires access to the cacheline before the state of the cacheline is returned to the first unit; and (d) if the second command received on the bus requires access to the cacheline before the state of the cacheline is returned to the first unit, store the second command in the buffer.

In a third aspect of the invention, a first system for reducing reissue latency of a command received in a command processing pipeline from one of a plurality of units coupled to a bus is provided. The first system includes (1) a bus; (2) one or more units coupled to the bus and adapted to issue a command on the bus; and (3) latency-reducing logic coupled to the bus. The latency-reducing logic includes (a) a buffer; and (b) a command processing pipeline coupled to the buffer. The latency-reducing logic is adapted to (i) from a first unit coupled to the bus, receive a first command on the bus requiring access to a cacheline; (ii) determine a state of the cacheline required by the first command by accessing cacheline state information stored in each of the plurality of units; (iii) determine whether a second command received on the bus requires access to the cacheline before the state of the cacheline is returned to the first unit; and (iv) if the second command received on the bus requires access to the cacheline before the state of the cacheline is returned to the first unit, store the second command in the buffer. Numerous other aspects are provided in accordance with these and other aspects of the invention.

Other features and aspects of the present invention will become more fully apparent from the following detailed description, the appended claims and the accompanying drawings.

### BRIEF DESCRIPTION OF THE FIGURES

FIG. 1 is a block diagram of a system for reducing command reissue latency in accordance with an embodiment of the present invention.

FIG. 2 is a block diagram of latency-reducing logic included in the system of FIG. 1 in accordance with an embodiment of the present invention.

### DETAILED DESCRIPTION

The present invention provides methods and apparatus for reducing command reissue latency. More specifically, the present system may include logic adapted to reduce reissue latency of commands in a command processing pipeline. The command reissue latency-reducing logic may include a memory (e.g., a contents addressable memory (CAM)) to track pending commands associated with different memory cachelines, respectively, which have been granted bus access. For example, the CAM may store data indicating a first command requiring access to a first memory cacheline, and a second command requiring access to a second memory cacheline were granted bus access and are still pending. Once a state of a cacheline associated with the first or second command is determined, a CAM entry associated with such a command may be removed. However, if the computer system receives an additional command (e.g., a third command) requiring access to a memory cacheline which is associated with a pending command, rather than retrying the additional command, the command reissue latency-reducing logic may remove the additional command from the pipeline by storing the command in a buffer until the state of the cacheline associated with the pending command is determined. Thereafter, the command reissue latency-reducing logic may remove the additional command from the buffer and re-insert the command into the pipeline. In this manner, the additional command may complete. A command processing delay introduced by processing the additional command in this manner is less than a delay introduced by retrying the command. Consequently, the additional command may complete faster than if the computer system retries the command. In this manner, the present methods and apparatus may reduce command reissue latency.

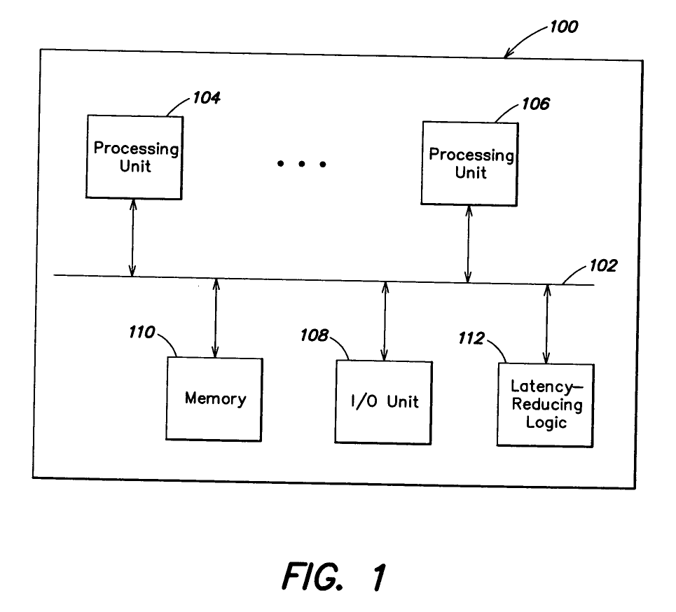

FIG. 1 is a block diagram of a system for reducing command reissue latency in accordance with an embodiment of the present invention. With reference to FIG. 1, the system 100 may include at least one bus 102 (only one shown) and one or more units coupled thereto, which are adapted to issue respective commands on the bus 102. For example, the system 100 may include one or more processing units 104, 106 and/or one or more input/output (I/O) units 108 coupled to the bus 102 and adapted to issue commands on the bus 102. Additionally, the system 100 may include a memory 110 coupled to the bus 102. In this manner, a processing unit 104, 106 or an I/O device 108 may access the memory 110 as desired. Further, the system 100 may include latency-reducing logic 112 (e.g., a single logic unit) coupled to the at least one bus 102. Such logic 112 may be adapted to reduce reissue latency of a command issued on the bus 102. For example, during system operation, a first processing unit 104 may issue a first command, requiring access to a cacheline, on the bus 102. Once such a command is received on the bus 102, a coherency window (e.g., snoop window) opens. During the snoop window, the first command requiring access to the cacheline may be transmitted (e.g., reflected) to the plurality of units 104, 106, 108 coupled to the bus 102. Upon receiving such command, each of the plurality of units 104, 106, 108 may access cacheline state information stored therein. Cacheline state information stored by a unit 104, 106, 108 may indicate a state of one or more cachelines as tracked by the unit 104, 106, 108. For example, each unit 104, 106, 108 may track the state of one or more cachelines using MESI protocol (although a different protocol may be employed). The MESI protocol is known to one of skill in the art, and therefore, is not described in detail herein. Based on such cacheline state information, each unit 104, 106, 108 may transmit the state of the cacheline required by the first processing unit 104 (as tracked by the unit 104, 106, 108) to the first processing unit 104. Such cacheline state information from the units 104, 106, 108 may collectively serve as a snoop response which indicates a state of the cacheline required by the first command. The snoop response may serve to close the snoop window.

After the first command is issued, a second command, which requires access to the same cacheline as the first command, may be issued on the bus 102. To maintain coherency (e.g., cache coherency), the latency-reducing logic 112 may not process the second command requiring access to the cacheline until a previous command (e.g., the first command) requiring access to the cacheline receives state information about the cacheline. To wit, the second command may not be processed until the snoop window for the first command closes. In a conventional system, if a second command requiring access to the same cacheline as a previously-received command (e.g., a first command) is received on the bus before the snoop window for the previously-received command completes, for example, the conventional system would retry the second command (e.g., re-issue the second command from the unit which originally issued the second command). However, retrying the command introduces a large command reissue latency in the conventional system. In contrast to the conventional system, rather than immediately retying such a command, the latency-reducing logic 112 of the system 100 may remove the second command from a command processing pipeline thereof and store the second command in a buffer until the snoop window for the previously-received command closes. Thereafter, the latency-reducing logic 112 may remove the stored second command from the buffer and re-insert the second command into the pipeline such that processing of the second command may commence (e.g., the snoop window of the second command may open and close).

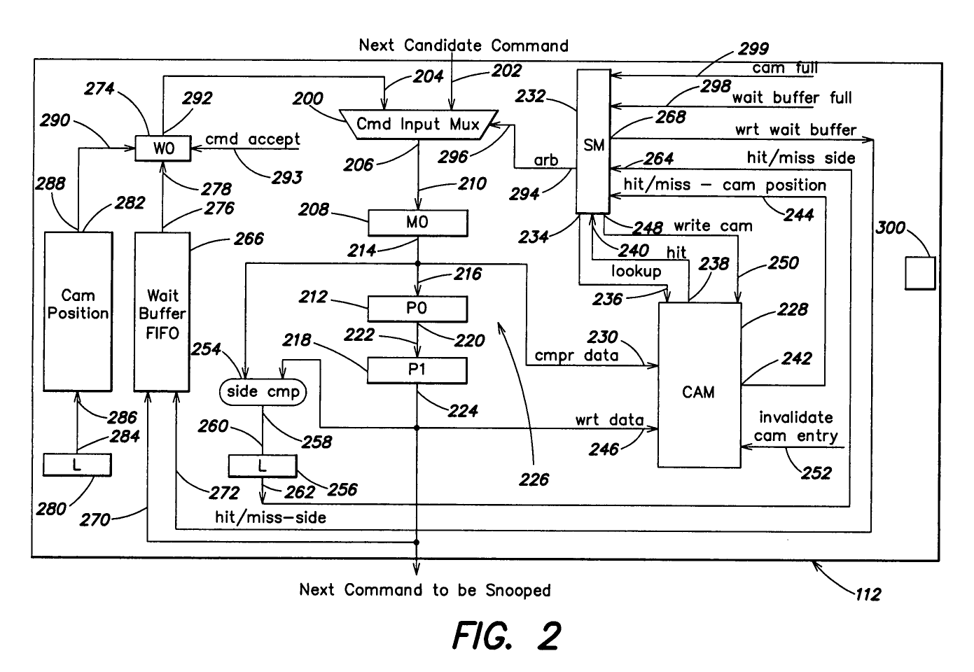

In the system 100, a command processing delay caused by removing the second command from the pipeline, storing the command in the buffer and re-inserting the command into the pipeline after the snoop window for the previously-received command closes (in the manner described above) may be less than a command processing delay caused by retrying the second command. Consequently, the logic 112 may reduce command reissue latency compared to conventional systems. Details of the structure and operation of the latency-reducing logic 112 are described below with reference to FIG. 2.

FIG. 2 is a block diagram of latency-reducing logic included in the system of FIG. 1 in accordance with an embodiment of the present invention. With reference to FIG. 2, the latency-reducing logic 112 may include a multiplexer 200 adapted to receive commands from a plurality of paths, respectively, and selectively output a command. More specifically, the multiplexer 200 may include a first input 202 coupled to a path from which new command may be received by the latency-reducing logic 112. Additionally, the multiplexer 200 may include a second input 204 coupled to a path on which a command removed by the pipeline (described below) may be re-inserted into the pipeline. Further, the multiplexer 200 may include an output 206 from which the multiplexer 200 may selectively output a command input by the inputs 202, 204.

The multiplexer 200 may be coupled to a first logic stage MO 208. More specifically, the output 206 of the multiplexer 200 may couple to an input 210 of the first logic stage 208. The first logic stage 208 may be adapted to store a command output from the multiplexer 200. The first logic stage 208 may be coupled to a second logic stage P0 212. More specifically, an output 214 of the first logic stage 208 may be coupled to an input 216 of the second logic stage 212. The second logic stage 212 may be adapted to store a command output from the first logic stage 208.

The second logic stage 212 may be coupled to a third logic stage P1 218. More specifically, an output 220 of the second logic stage 212 may be coupled to an input 222 of the third logic stage 218. The third logic stage 218 may be adapted to store a command output from the second logic stage 212. A command output via an output 224 of the third logic stage 218 may be the next command to be processed. For example, processing of such a command may begin by snooping the command (e.g., opening and closing a snoop window for the command).

The multiplexer 200 and first through third logic stages 208, 212, 218 may form the command processing pipeline 226 of the system 100. However, the command processing pipeline 226 may include larger or smaller number of stages and/or different stages. Further, the first, second and third logic stages 208, 212, 218 may each include a register (although the first, second and/or third logic stages 208, 212, 218 may include a larger or smaller amount of and/or different logic).

The command processing pipeline 226 may be adapted to receive a command every other cycle. Consequently, when a first command received in the pipeline 226 reaches the third stage 218, the next consecutive command (e.g., a second command) received in the pipeline 226 may be in the first stage 208.

The latency-reducing logic 112 may include a memory (e.g., a contents addressable memory (CAM)) 228 coupled to the first stage 208. More specifically, the output 214 of the first stage 208 may be coupled to a first input 230 of the CAM 228 on which data (e.g., a command) to be compared to the data stored by the CAM 228 may be input.

Additionally, the CAM 228 may be coupled to a state machine (SM) 232 adapted to receive one or more signals and generate and output one or more signals based thereon. More specifically, a first output of the SM 234 may be coupled to a second input 236 of the CAM 228. The state machine 232 may be adapted to output a lookup signal that is input by the CAM 228. The lookup signal may indicate to the CAM 228 when data input by the first input 230 of the CAM 228 should be compared to data stored by the CAM 228. Further, the CAM 228 may include a first output 238 coupled to a first input 240 of the SM 232. The CAM 228 may be adapted to output a signal indicating whether data input by the first input 230 of the CAM 228 matched data stored by the CAM 228 (e.g., whether the CAM lookup resulted in a hit). Additionally, a second output 242 of the CAM 228 may be coupled to a second input 244 of the SM 232. The CAM 228 may be adapted to output a signal hit/miss cam position indicating a position of a CAM entry storing data which matched that input by the first input 230.

Additionally, the output 224 of the third stage 218 may be coupled to a third input 246 of the CAM 228 on which data to be written to (e.g., stored by) the CAM 228 may be provided. Further, a second output 248 of the SM 232 may be coupled to a fourth input 250 of the CAM 228. The SM 232 may be adapted to output (e.g., via the second output 248) a write cam signal that is input by the CAM 228. The write cam signal may indicate to the CAM 228 when data input by the third input 246 of the CAM 228 should be stored by an entry of the CAM 228. The SM 232 may assert the write cam signal based on the results of the previously-performed CAM lookup. For example, when a first command requiring access to a cacheline is output from the first stage 208 to the second stage 212, the first command is also compared with data stored in the CAM 228 to determine whether the CAM 228 stores a previously-received command requiring access to the same cacheline. If the CAM lookup results in a miss (e.g., does not result in a hit), when the first command is output from the third stage 218, the latency-reducing logic 112 may write the first command into the CAM 228. Further, the first command is the next command to be snooped. More specifically, a snoop window opens for the first command, and therefore, the first command may be transmitted (e.g., reflected) to all units 104, 106, 108 coupled to the bus 102.

Additionally, the CAM 228 may be adapted to receive an invalidate cam entry signal via a fifth input 252. The invalidate cam entry signal may be employed to remove an entry from the CAM 228 corresponding to a command requiring a cacheline, the state of which has been determined (e.g., a command whose snoop window has closed). For example, once all units 104, 106, 108 provide respective tracked states of the cacheline required by the first command to the unit 104, 106, 108 that issued the first command (e.g., the first unit 104) the state of the cacheline is determined.

Further, the latency-reducing logic 112 may include side compare logic 254 adapted to compare a first command output by the third stage 218 (before the first command may be written into the CAM 228) with a second command output by the first stage 208 to determine whether such command requires access to the same cacheline. The side compare logic 254 may be adapted to output a hit/miss—side signal indicating the result of the above-described comparison. In this manner, the side compare logic 254 may determine whether a first and second command received in the pipeline 226 within a small time period (e.g., received within a first and third cycle) require access to the same cacheline.

The side compare logic 254 may be coupled to a first latch 256 adapted to store the result of the above-described comparison. More specifically, an output 258 of the side compare logic 254 may be coupled to an input 260 of the first latch 256. An output 262 of the first latch 256 may be coupled to a third input 264 of the SM 232. Consequently, the hit/miss—side signal may be input by the SM 232. The SM 232 may be adapted to generate a wrt wait buffer signal based on the hit and/or hit/miss—side signals. The SM 232 may output (e.g., via a third output 268) the wrt wait buffer signal to a buffer 266 (e.g., a wait buffer FIFO) included in the latency-reducing logic 112. The wrt wait buffer signal may indicate that a second command received by the latency-reducing logic 112 matches a previously-received first command whose snoop window is pending. To wit, the wrt wait buffer signal may indicate that a second command received by the latency-reducing logic 112 requires access to the same cacheline as a previously-received first command whose snoop window is pending. Therefore, the wrt wait buffer signal may indicate processing of the second command should be delayed until the first command is notified of the cacheline state (e.g., until the snoop window of the first command closes).

More specifically, the latency-reducing logic 112 may include a buffer 266 having a first input 270 coupled to the output 224 of the third stage 218. Additionally, the third output 268 of the SM 232 may be coupled to a second input 272 of the buffer 266 such that the wrt wait buffer signal may be input via such input 272. For example, when the wrt wait buffer signal is asserted on the second input 272, data (e.g., a command) output from the third stage 218 may be stored in the buffer 266 rather than processed (e.g., reflected to units 104, 106, 108 coupled to the bus 102 as part of a snoop window for the command). In this manner, during system operation, the buffer 266 may store any command that matches a previously-received command whose snoop window is pending.

The buffer 266 may be coupled to a pipeline re-insertion stage W0 274. More specifically, an output 276 of the buffer 266 may be coupled to a first input 278 of the pipeline re-insertion stage 274. Additionally, the latency-reducing logic 112 may include a second latch 280 adapted to store a position of a CAM entry that matched (e.g., hit) a command input by the buffer 266. The second latch 280 may be coupled to CAM position logic 282. More specifically, an output 284 of the second latch 280 may be coupled to an input 286 of the CAM position logic 282. By inputting data from the second latch 280, the CAM position logic 282 may track a CAM entry position that resulted in a hit for each command stored in the buffer 266. The CAM position logic 282 may be coupled to the pipeline re-insertion stage 274. More specifically, an output 288 of the CAM position logic 282 may be coupled to a second input 290 of the pipeline re-insertion stage 274. The CAM position logic 282 may be adapted to determine a command stored in the buffer 266 may be re-inserted into the command processing pipeline 226 and output a signal indicating such to the pipeline re-insertion stage 274. For example, the CAM position logic 282 may employ the invalidate cam entry signal to determine commands, which are stored by a CAM entry, whose snoop window closes and respective positions of CAM entries that matched commands input by the buffer 266 to determine a command stored in the buffer 266 may be re-inserted in the command processing pipeline 226 and generate a signal indicating such.

When such a signal is asserted, a corresponding entry (e.g., command) output from the buffer 266 may be input by the pipeline re-insertion stage 274. An output 292 of the pipeline re-insertion stage 274 may be coupled to the second input 204 of the multiplexer 200. Therefore, during a given time period, the multiplexer 200 of the command processing pipeline 226 may receive a new command requiring access to a cacheline and/or a command requiring access to a cacheline output from the buffer 266. Further, signal cmd accept may be input by (e.g., via a third input 293 of) the pipeline re-insertion stage 274. Signal cmd accept may indicate the pipeline re-insertion stage 274 may store another command from the buffer 266 (e.g., because the command previously stored in the stage 274 has been re-inserted into the pipeline 226 via the multiplexer 200). The cmd accept signal may be based on signal arb (described below).

The multiplexer 200 may be coupled to the SM 232. More specifically, a fourth output 294 of the SM 232 may be coupled to a third input (e.g., a control input) 296 of the multiplexer 200. The SM 232 may be adapted to generate and output the signal arb from the fourth output 294 such that the signal arb may be input by the multiplexer 200 via the third input 294. The multiplexer 200 may selectively output a command input by the first or second input 202, 204 thereof based on the signal arb. The SM 232 may be adapted to track a status of the pipeline 226 (e.g., track a number of commands and respective positions of such commands in the pipeline 226) and generate the signal arb based on the pipeline status.

In this manner, the latency-reducing logic 112 may remove from the pipeline 226 a second command that requires access to the same command required by a previously-received command whose snoop window is closed. The second command may be stored in the buffer 266 until the snoop window of the first command closes. Thereafter, the second command may be re-inserted into the pipeline 226 for processing. In this manner, the second command may be processed faster than if the second command is retried (e.g., is subsequently reissued from the unit which originally issued the second command). More specifically, removing the second command from the pipeline 226, storing the command in the buffer 266, removing the command from the buffer 266 and subsequently re-inserting the command into the pipeline 226 may introduce a smaller delay than that introduced by retrying the second command during processing.

Additionally, the SM 232 may receive a signal wait buffer full input via a fourth input 298 of the SM 232. Signal wait buffer full may indicate the buffer 266 is full, and therefore, no more entries (e.g., commands) may be stored therein. Therefore, when signal wait buffer full is asserted, the latency-reducing logic 112 may prevent receipt of new commands in the pipeline 226. For example, the system 100 may stall new candidates (e.g., commands) from entering the pipeline 226 until an entry in the buffer 266 is available (e.g., frees up) to store another command. However, because stalling new commands may cause system command traffic to grind to a halt, such an action adversely affects system operation. Alternatively, when the signal wait buffer full is asserted, the latency-reducing logic 112 may receive additional commands in the pipeline 226. However, rather than storing new commands which result in a CAM hit in the buffer 266, the latency-reducing logic 112 may retry the commands (e.g., reflect the new commands but mark such commands for retry). A reflected command may be marked for retry during the AStat window (described below) employed by a 6XX bus manufactured by the assignee of the present invention, IBM Corporation of Armonk, N.Y. In this manner, the new command may be allowed to proceed but marked such that the new command may receive a snoop response retry. Because the latter action keeps the pipeline running, such action may be preferred over the former when the buffer 266 is full. However, during operation of a properly-architected system 100, well-behaved code executed by the system 100 will not fill up the buffer 266. Consequently, the full benefits (e.g., command reissue latency reduction) of the present methods and apparatus may be realized a vast majority of the time.

Further, the SM 232 may receive a signal cam full input via a fifth input 299 of the SM 232. Signal cam full may indicate the CAM 228 is full, and therefore, no more entries (e.g., commands) may be stored therein. Therefore, the cam full signal may indicate a maximum number of coherent commands are in flight in the system 100, and therefore, the system 100 may not receive any new commands in the pipeline 226. However, new commands which do not require snooping may also pass through the pipeline 226 and without being tracked by the CAM 228. Thus, the CAM size may limit a number of coherent commands in flight, but only indirectly limit a total number of commands in flight because once the CAM fills up, if a “next” command is a coherent one, the pipeline 226 will stall until a CAM entry is available. The latency-reducing logic 112 may include logic 300 adapted to track the CAM 228 and/or buffer 266 and generate the wait buffer signal and/or cam full signal based on such tracking.

Configuration of the latency-reducing logic 112 is exemplary, and therefore, the latency-reducing logic 112 may be configured differently. For example, the latency-reducing logic 112 may include a larger or smaller amount of and/or different logic.

### Exemplary Scenario #1

A first exemplary scenario of operation of the system 100 is described below. During a first time period (e.g., one or more clock cycles), the multiplexer 200 may receive on a first input 202 thereof a new command (e.g., a first command) requiring access to a first cacheline. The multiplexer 202 may selectively output the first command such that the first command is stored by the first stage 208 during a second time period.

During a third time period, the first command may be stored in the second stage 212. Further, the latency-reducing logic 112 may compare the first command with entries stored by the CAM 228 to determine whether a command stored in the CAM 228 requires access to the same cacheline as the first command. It is assumed the above-described comparison (e.g., lookup) results in a miss. Additionally, the side compare logic 254 may compare the first command with a previously-received command output from the third stage 218 during the third time period to determine if such commands require access to the same cachelines. It is assumed such commands do not, and such side compare logic result (e.g., the hit/miss—side signal) may be transmitted to the SM 232 during a subsequent time period. Further, during the third time period, the multiplexer 200 may receive a second command (e.g., via the first input 202 thereof) that requires access to a second cacheline.

During a fourth time period, the first command may be stored in the third stage 218. Because of the CAM miss during the third time period, during the fourth time period, the latency-reducing logic 112 may begin to write the first command into the CAM 228. However, the write may complete during a subsequent time period. It is assumed processing of the previously-received command commences (e.g., a snoop window for such previously-received command opens and the previously-received command is reflected to units 104, 106, 108 coupled to the bus 102). Additionally, the second command may be stored in the first stage 208. Further, the side compare logic 254 may compare the second command with the first command output from the third stage 218 during the fourth time period to determine is such commands require access to the same cachelines. Because the first command requires access to a first cacheline and the second command requires access to a second cacheline, the compare logic 254 determines the commands do not, and such result (e.g., the hit/miss—side signal) may be transmitted to the SM 232 during a subsequent time period. Therefore, the path of the second command through the pipeline 226 may be unaffected by the first command. Consequently, it is assumed the second command travels through the pipeline 226 during subsequent time periods and processing of such command commences. Thus additional details of the path of the second command are not described herein.

During a fifth time period, the write of the first command may into the CAM 228 may complete. Further, the processing of the first command commences (e.g., a snoop window for the first command opens and the first command may be reflected to units 104, 106, 108 coupled to the bus 102). Also, the multiplexer 200 may receive on a first input 202 thereof a new command (e.g., a third command) requiring access to the first cacheline. The multiplexer 200 may selectively output the third command such that the third command is stored by the first stage 208 during a sixth time period.

Although additional commands may travel through the pipeline 226 and signals related thereto may be asserted in the latency-reducing logic 112, for convenience, the remaining description of this exemplary scenario focuses on the third command and signals associated therewith. During the seventh time period, the third command may be stored in the second stage 212. Further, the latency-reducing logic 112 may compare the third command with entries stored by the CAM 228 to determine whether a command stored in the CAM 228 requires access to the same cacheline as the third command. It is assumed the first unit has not been informed of the state of the first cacheline, and therefore, the snoop window of the first command is pending. Consequently, the first command may remain in the CAM 228. Therefore, the above-described comparison results in a CAM hit. Consequently, during a subsequent time period, the third command may travel through the third stage 218 of the pipeline 226. Thereafter, the third command may be stored in the buffer 266.

When the snoop window of the first command completes, the invalidate cam entry signal may be employed to remove the CAM entry corresponding to the first command from the CAM 228. Further, such signal may be employed to indicate the third command may be removed from the buffer 266, and thereafter, re-inserted into the pipeline 226. Once re-inserted into the pipeline 226, the third command may travel through stages 208, 212, 218 of the pipeline 226 such that processing of the third command commences (e.g., a snoop window for the third command opens and the third command is reflected to units 104, 106, 108 coupled to the bus 102). Once the snoop window for the third command closes, processing of the third command may complete. The above-described path of the third command (e.g., through the buffer 266) may enable the third command to be processed faster than if the latency-reducing logic 112 retried the third command. For example, the above-described path of the third command may introduce about half as much delay to command processing as retrying the third command. Consequently, when the third command follows the above-described path, the command may be processed two times faster than if the command is retried. However, the latency-reducing logic 112 may provide a larger or smaller improvement in command processing.

### Exemplary Scenario #2

A second exemplary scenario of operation of the system 100 is described below. The second exemplary scenario describes how commands which require access to the same cacheline that are received by the pipeline 226 in a short time period (e.g., consecutive commands received within a first and third clock cycle) are processed. During a first time period (e.g., one or more clock cycles), the multiplexer 200 may receive, on a first input 202 thereof, a new command (e.g., a first command) requiring access to a first cacheline. The multiplexer 200 may selectively output the first command such that the first command is stored by the first stage 208 during a second time period.

During a third time period, the first command may be stored in the second stage 212. Further, the latency-reducing logic 112 may compare the first command with entries stored by the CAM 228 to determine whether a command stored in the CAM 228 requires access to the same cacheline as the first command. It is assumed the above-described comparison (e.g., a lookup) results in a miss. Additionally, the side compare logic 254 may compare the first command with a previously-received command output from the third stage 218 during the third time period to determine is such commands require access to the same cachelines. It is assumed such commands do not, and such side compare logic result (e.g., the hit/miss—side signal) may be transmitted to the SM 232 during a subsequent time period. Further, during the third time period, the multiplexer 200 may receive a second command that requires access to the first cacheline.

During a fourth time period, the first command may be stored in the third stage 218. Because of the CAM miss during the third time period, during the fourth time period, the latency-reducing logic 112 may begin to write the first command into the CAM 228. However, the write may complete during a subsequent time period. It is assumed processing of the previously-received command commences (e.g., a snoop window for such previously-received opens and the previously-received is reflected to units 104, 106, 108 coupled to the bus 102). Additionally, the second command may be stored in the first stage 208. Further, the latency-reducing logic 112 may compare the second command with entries stored by the CAM 228 to determine whether a command stored in the CAM 228 requires access to the same cacheline as the second command. Although the first command is being written to the CAM 228, such a write may not have completed before the above-described comparison is performed because the first and second commands were received in a short time period. Therefore, the above-described comparison may result in a miss. Such a result may be transmitted to the SM 232 during a subsequent time period. Additionally, the side compare logic 254 may compare the second command with the first command output from the third stage 218 during the fourth time period to determine is such commands require access to the same cachelines. Because the first and second commands require access to the first cacheline, the compare logic determines the commands require access to the same cacheline, and such side compare logic result (e.g., the hit/miss—side signal) may be transmitted to the SM 232 during a subsequent time period.

During a fifth time period, the write of the first command into the CAM 228 may complete. Further, processing of the first command commences (e.g., a snoop window for the first command opens and the first command may be reflected to units 104, 106, 108 coupled to the bus 102). Additionally, the second command may be stored in the second stage 212.

Although additional commands may travel through the pipeline 226 and signals related thereto may be asserted in the latency-reducing logic 112, for convenience, the remaining description of this exemplary scenario focuses on the second command and signals associated therewith. During a sixth time period, the second command may be stored in the third stage 218. Based on the hit signal and hit/miss—side signal provided to the SM 232, the latency-reducing logic 112 may treat the comparison of the second command with the CAM 228 as essentially resulting in a hit. Consequently, thereafter, the second command may be stored in the buffer 266.

When the snoop window of the first command completes, the invalidate cam entry signal may be employed to remove the entry corresponding to the first command from the CAM 228. Further, such signal may be employed to indicate the second command may be removed from the buffer 266, and thereafter, re-inserted to the pipeline 226. Once re-inserted into the pipeline 226, the second command may travel through stages 208, 212, 218 of the pipeline 226 such that processing of the second command commences (e.g., a snoop window for the second command opens and the second command is reflected to units 104, 106, 108 coupled to the bus 102). Once the snoop window for the second command closes, processing of the second command may complete. The above-described path of the second command (e.g., through the buffer 266) may enable the second command to be processed faster than if the latency-reducing logic 112 retried the second command. For example, the above-described path of the second command may introduce about half as much delay to command processing as retrying the second command. Consequently, when the second command follows the above-described path, the command may be processed two times faster than if the command is retried. However, the latency-reducing logic 112 may provide a larger or smaller improvement in command processing.

In summary, during operation of the system, every command that requires access to a cacheline whose coherency should be maintained (e.g., cache-coherent command) that is reflected to units 104, 106, 108 of the bus 102 may be tracked by the CAM array 228 until a snoop window for the command completes. A new (e.g., next) command to be reflected and snooped may be sent down the pipeline 226, where it is compared against the contents of the CAM 228. If such comparison results in a CAM miss, the new command may be reflected to the bus units 104, 106, 108, and the command (e.g., the command and/or an address associated therewith) may be stored in the next CAM entry. Alternatively, if such comparison results in a CAM hit, the command may be set aside in a “wait buffer” 266 until a CAM entry the new command hit against is retired (e.g., by a snoop response that closes the snoop window for the command stored in such entry). Additionally, a pointer to the CAM entry that the next command hit against may be stored. As snoop responses associated with prior commands return, such responses may invalidate the corresponding CAM entries, and also pull or release any matching buffer entries. Once a buffer entry is released, the entry is sent down the pipeline 226 again, and the process may repeat. In this manner, a command that was set aside may then be pulled from the wait buffer 266 and re-inserted into the command stream (e.g., into the pipeline 226). An amount of time such a command is held on the side may average roughly half the time it takes to reflect, retry and reissue the command. Additionally, the system 100 may employ the side compare logic 254 to detect back-to-back first and second matching commands before the system 100 has successfully stored the first command in the CAM 228.

As stated, the above two operational scenarios are exemplary. Consequently, the system 100 may receive and process commands in a different manner, and therefore, the latency-reducing logic 112 may improve command processing in various ways.

The present methods and apparatus may provide advantages over conventional systems. For example, coherent Symmetric Multiprocessor (SMP) buses of conventional system experience problems with closely-spaced commands trying to change a cache state of a cacheline at a rate faster than the bus (e.g., snoop logic thereof) can update the cache state. This condition is sometimes known as Prior Adjacent Address Match (PAAM) collision. The conventional system solves this problem by accepting the first command that reaches the bus, and retrying all subsequently-received commands that request the same cacheline until a coherency window (e.g., snoop window) for the first command has completed and the new cache state is known. For example, the conventional system may include an RS/6000 processor including the IBM 6XX bus. Such a system employs two response windows for each command. The first response, AStat, occurs shortly after the command, and can be used by devices coupled to the bus that are too busy to look at the command to retry the command, and to perform the above-mentioned retry of a snooped command that was too close behind a prior command requiring access to the same cacheline. The second response, AResp, is the final response to the command which provides or determines the resulting cache state for the cacheline. Thus, in such a system, a command which follows a previously-received matching command, but arrives on the bus prior to AResp for the prior command, is retried with the AStat response. Consequently, the unit which originally issued the command (e.g., the sourcing unit) resends the command until the command succeeds. However, as described above, retrying a command in this manner (especially in a system that requires chip crossing to process the command), may introduce a large command reissue latency.

To avoid the problems of such conventional systems, the present invention may reduce command reissue latency by filtering from the pipeline a command whose address conflicts with that of a previously-received command, and re-inserting the filtered command into the pipeline when the conflict is resolved (e.g., when the snoop window for the previously-received command closes). For example, the present methods and apparatus may detect a PAAM collision and set aside a command, which collides with a prior command, until a snoop window of the prior command completes and then reflect the command to the units 104, 106, 108. Such a method may take less than half the time of the retry method. Also, such a method may be employed when multiple commands contend for the same address, to space (e.g., optimally) such commands in the pipeline logic 226. Consequently, the present methods and apparatus may process such commands more efficiently than the conventional system.

The foregoing description discloses only exemplary embodiments of the invention. Modifications of the above-disclosed apparatus and methods which fall within the scope of the invention will be readily apparent to those of ordinary skill in the art. For instance, as stated, the above-described latency-reducing logic 112 may be adapted to receive a command (e.g., a cache-coherent command) in the pipeline 226 every other clock cycle. However, in some embodiments, the latency-reducing logic 112 may be modified to receive a command in the pipeline 226 every cycle. Such a modification is known to one of skill in the art. For example, the output 220 of the second stage 212 rather than the output 224 of the third stage 218 may be coupled to the side compare logic 254. Further, the CAM 228 described above may have a 2-cycle access time. However, in some embodiments, the CAM 228 may have a longer or shorter access time. In such embodiments, the pipeline 226 may be modified accordingly. Such a modification is known to one of skill in the art. For example, the pipeline 226 may include a larger number of stages to accommodate a CAM 228 with a longer access time or a smaller number of stages to accommodate a CAM 228 with a shorter access time.

By employing a single latency-reducing logic unit 112 coupled to the at least one bus unit 102, the present methods and apparatus may remove address-collision circuitry from every bus unit and concentrate such circuitry in one place (e.g., employ one unit for all buses instead of separate units corresponding to the buses, respectively). Consequently, the present methods and apparatus may substantially reduce overall chip area consumed by logic when a large number of bus units are employed.

Accordingly, while the present invention has been disclosed in connection with exemplary embodiments thereof, it should be understood that other embodiments may fall within the spirit and scope of the invention, as defined by the following claims.

The invention claimed is:

1. A method of reducing reissue latency of a command received in a command processing pipeline from one of a plurality of units coupled to a bus, comprising:
from a first unit coupled to the bus, receiving a first command on the bus requiring access to a cacheline;
determining a state of the cacheline required by the first command by accessing cacheline state information stored in each of the plurality of units;
determining whether a second command received on the bus requires access to the cacheline before the state of the cacheline is returned to the first unit; and
if the second command received on the bus requires access to the cacheline before the state of the cacheline is returned to the first unit, storing the second command in a buffer.

2. The method of claim 1 further comprising storing the first command requiring access to the cacheline in a memory;
wherein determining whether the second command received on the bus requires access to the cacheline before the state of the cacheline is returned to the first unit includes determining whether the memory stores a command requiring access to the cacheline.

3. The method of claim 2 wherein determining whether the second command received on the bus requires access to the cacheline before the state of the cacheline is returned to the first unit further includes employing compare logic to determine whether the second command requires access to the cacheline required by the first command.

4. The method of claim 1 further comprising:
after the state of the cacheline is returned to the first unit, removing the second command requiring access to the cacheline from the buffer; and
re-inserting the second command into the pipeline.

5. The method of claim 4 further comprising determining a state of the cacheline required by the second command by accessing cacheline state information stored in each of the plurality of units.

6. The method of claim 1 wherein storing the second command in the buffer includes storing the second command in a first-in-first-out buffer.

7. The method of claim 1 further comprising, if the buffer is full:
marking the second command such that the second command receives a snoop response retry; or
stopping receipt of new commands in the pipeline.

8. The method of claim 1 wherein determining whether the second command received on the bus requires access to the cacheline before the state of the cacheline is returned to the first unit includes employing compare logic to determine whether the second command requires access to the cacheline required by the first cacheline.

9. An apparatus for reducing reissue latency of a command received in a command processing pipeline from one of a plurality of units coupled to a bus, comprising:
latency-reducing logic including:
a buffer; and
a command processing pipeline coupled to the buffer;
wherein the latency-reducing logic is adapted to:
from a first unit coupled to the bus, receive a first command on the bus requiring access to a cacheline;
determine a state of the cacheline required by the first command by accessing cacheline state information stored in each of the plurality of units;
determine whether a second command received on the bus requires access to the cacheline before the state of the cacheline is returned to the first unit; and
if the second command received on the bus requires access to the cacheline before the state of the cacheline is returned to the first unit, store the second command in the buffer.

10. The apparatus of claim 9 wherein:
the latency-reducing logic further comprises a memory coupled to the command processing pipeline; and
the latency-reducing logic is further adapted to:
store the first command requiring access to the cacheline in the memory; and
determine whether the second command received on the bus requires access to the cacheline before the state of the cacheline is returned to the first unit by determining whether the memory stores a command requiring access to the cacheline.

11. The apparatus of claim 10 wherein:
the latency-reducing logic further comprises compare logic; and
the latency-reducing logic is further adapted to employ the compare logic to determine whether the second command requires access to the cacheline required by the first command.

12. The apparatus of claim 9 wherein the latency-reducing logic is further adapted to:
after the state of the cacheline is returned to the first unit, remove the second command requiring access to the cacheline from the buffer; and
re-insert the second command into the pipeline.

13. The apparatus of claim 12 wherein the latency-reducing logic is further adapted to determine a state of the cacheline required by the second command by accessing cacheline state information stored in each of the plurality of units.

14. The apparatus of claim 9 wherein the buffer is a first-in-first-out buffer.

15. The apparatus of claim 9 wherein the latency-reducing logic is further adapted to, if the buffer is full:
mark the second command such that the second command receives a retry snoop response; or
stop receipt of new commands in the pipeline.

16. The apparatus of claim 9 wherein:
the latency-reducing logic further comprises compare logic coupled to the command processing pipeline; and
the latency-reducing logic is further adapted to employ the compare logic to determine whether the second command requires access to the cacheline required by the first command.

17. A system for reducing reissue latency of a command received in a command processing pipeline from one of a plurality of units coupled to a bus, comprising:
a bus;
one or more units coupled to the bus and adapted to issue a command on the bus; and
latency-reducing logic coupled to the bus;
wherein:
the latency-reducing logic includes:
a buffer; and
a command processing pipeline coupled to the buffer; and
the latency-reducing logic is adapted to:
from a first unit coupled to the bus, receive a first command on the bus requiring access to a cacheline;
determine a state of the cacheline required by the first command by accessing cacheline state information stored in each of the plurality of units;
determine whether a second command received on the bus requires access to the cacheline before the state of the cacheline is returned to the first unit; and
if the second command received on the bus requires access to the cacheline before the state of the cacheline is returned to the first unit, store the second command in the buffer.

18. The system of claim 17 wherein the latency-reducing logic further comprises a memory coupled to the command processing pipeline; and
the latency-reducing logic is further adapted to:
store the first command requiring access to the cacheline in the memory; and
determine whether the second command received on the bus requires access to the cacheline before the state of the cacheline is returned to the first unit by determining whether the memory stores a command requiring access to the cacheline.

19. The system of claim 18 wherein:
the latency-reducing logic further comprises compare logic; and
the latency-reducing logic is further adapted to employ the compare logic to determine whether the second command requires access to the cacheline required by the first command.

20. The system of claim 17 wherein the latency-reducing logic is further adapted to:
after the state of the cacheline is returned to the first unit, remove the second command requiring access to the cacheline from the buffer; and
re-insert the second command into the pipeline.

21. The system of claim 20 wherein the latency-reducing logic is further adapted to determine a state of the cacheline required by the second command by accessing cacheline state information stored in each of the plurality of units.

22. The system of claim 17 wherein the buffer is a first-in-first-out buffer.

23. The system of claim 17 wherein the latency-reducing logic is further adapted to, if the buffer is full:
mark the second command such that the second command receives a retry snoop response; or
stop receipt of new commands in the pipeline.

24. The system of claim 17 wherein:
the latency-reducing logic further comprises compare logic coupled to the command processing pipeline; and
the latency-reducing logic is further adapted to employ the compare logic to determine whether the second command requires access to the cacheline required by the first command.
